(19) United States
(12) Patent Application Publication
(10) Pub. No.: US 2007/0065272 A1
(43) Pub. Date: Mar. 22, 2007

(54) Centrifugal water lift electrical generator

(76) Inventor: Eugene R. Maple, Las Vegas, NV (US)

Correspondence Address: MEREK, BLACKMON & VOORHEES, LLC, 673 S. WASHINGTON ST., ALEXANDRIA, VA, 22314, US

(21) Appl. No.: 11/230,559

(22) Filed: Sep. 21, 2005

(51) Int. Cl. F03B 13/12

(52) U.S. Cl. 415/3.1

(57) ABSTRACT

A water lift generator system for generating electricity by a water system propelled by the force of water cycling through the system. A multi-reservoir water lift system includes a central reservoir having lower jets for rotating the reservoir. A basin below the reservoir catches water falling from the reservoir and has a number of fins for receiving rotational force from water exiting the reservoir jets. Rotation of the basin causes water to exit the basin and by siphon and centrifugal force to be lifted to an upper trough before being returned to the reservoir. A water supply may be provided at the top of the system to provide a continuous cycle.

### BACKGROUND OF THE INVENTION

1. Field of the Invention

The present invention relates to a water lift for generating electricity by the rotation of a self-rotating water system while providing a novel water flow device.

2. Description of the Prior Art

The use of water to generate power is well known and is employed in diverse operations from hydroelectric dams to small village grinding mills powered by local streams. The power of rushing current represents an immense potential power source still relatively unutilized today. Tapping even a small portion of the potential energy of a falling water through the use of a water wheel or other device could severely impact the amount of electricity which traditional power plants would need to generate, saving the limited fossil fuel supply for our future generations.

Through the novel routing of water through a water lift system, the amount of electricity generated by a water lift system can be maximized. Potential energy in a water reservoir can be converted to kinetic energy causing rotation of the system, which in turn can drive a generator to create electricity. By carefully tapping a portion of the energy generated by the downward flow to lift water back to the top of the system, the total time that the system can operate without requiring additional water or energy can be extended. Additionally, through the use of low friction bearing and the careful location of parts, the system can rotate with little overall drag and friction losses.

None of the above inventions and patents, taken either singly or in combination, is seen to describe the instant invention as claimed.

### SUMMARY OF THE INVENTION

Accordingly, it is a principal object of the invention to provide a novel and unique water lift system that uses a continuous water cycle which will be self-powering and will generate power.

It is another object of the invention to provide a water lift system in which the entire flow system is visible for entertainment and education.

It is a further object of the invention to provide a water lift system having a main reservoir terminating in a plurality of jets to provide rotation to the reservoir.

Still another object of the invention is to provide a catch basin having a plurality of fins designed to catch water from the jets to cause the catch basin to rotate.

It is yet another object of the invention to provide a plurality of up pipes connected to the catch basin to raise water in the catch basin up to the inlet of the reservoir to provide a continued supply of water to the reservoir for extended rotation of the water lift system.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is perspective view of the invention according to a preferred embodiment.

FIG. 2 is a partial, diagrammatic view of the invention according to a second embodiment.

FIG. 2 is a diagrammatic view of the invention according to a second embodiment as viewed from the top.

Similar reference characters denote corresponding features consistently throughout the attached drawings.

### DETAILED DESCRIPTION OF THE PREFERRED EMBODIMENT(s)

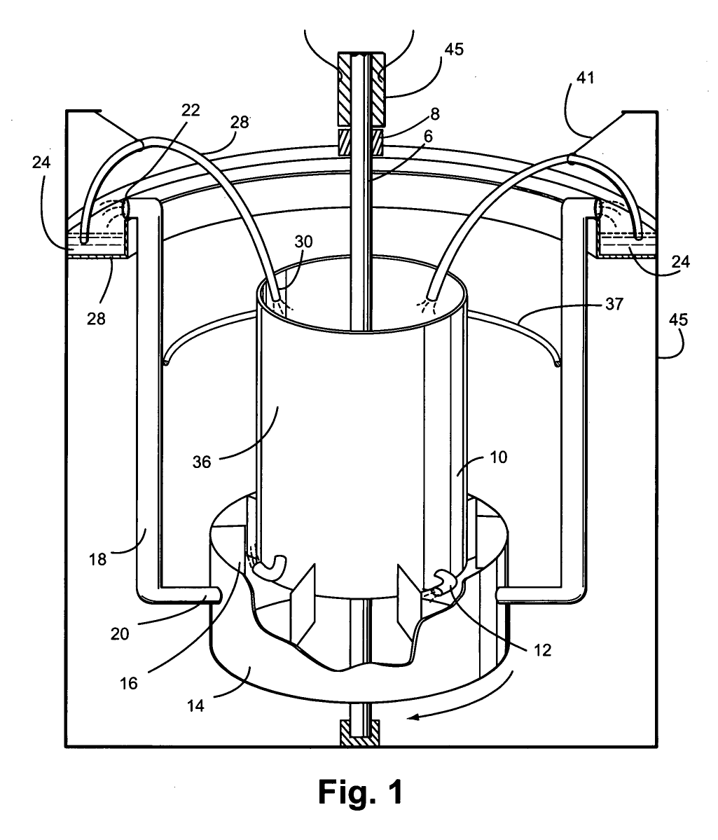

The present invention is to a water lift system as shown in FIG. 1. According to a preferred embodiment of the invention, the water lift has a central reservoir 10 that holds a fluid such as water. The reservoir rotates under the force caused by water issuing from jets 12 located at the bottom of the reservoir and angled to cause rotational thrust in a counterclockwise rotation. As water flows through the jets 12, the force causes the reservoir 10 to rotate counterclockwise.

A catch basin 14 is provided below the central reservoir 10 to catch water from the reservoir jets. Water issuing from the jets strikes a number of fins 16 attached to an inner wall of the basin 14 to cause a counter-rotational force on the basin, thus rotating the basin 14 in a clockwise direction, opposite the direction of the reservoir.

The rotation of the catch basin 14 creates a centrifugal force that forces the water in the catch basin outward. When rotation reaches a certain velocity the centrifugal force will cause water to exit the basin and enter the up pipes 18. While two up pipes are shown here, one skilled in the art would recognize that more pipes could be used, with four pipes being preferred for balance and total water flow. If the water pipes are initially full of water, water entering the up pipes 18 under centrifugal force will exit out the nozzle 22 into a stationary trough 24 surrounding the up pipes. As water exits out the nozzle, additional water will be drawn through the up pipes from the entrance 20 through the pipe to the exit 22 under a siphon principle. The centrifugal force will tend to counterbalance the gravity on the pipes and a centrifugal siphon will be created in the up pipes 18 to lift the water from the basin 18 into the trough 24. A central brace 37 may be provided connecting the up pipes together to give the up pipes rigidity to maintain their shape during rotation about the central reservoir.

The trough is preferably ring-shaped surrounding the up pipes, but can have a different shape as needed. A ring shape allows the up pipes 18 to rotate within the trough without rubbing against the trough. Additionally, the ring shape allows the trough to catch the water from the up pipe spout 22 continuously without regard to the current rotational position of the up pipes as they turn within the inner radius of the trough.

Once the water has collected into the trough, the water must be reintroduced to the central reservoir 10 so that it can be used to continue the rotational velocity of the central reservoir and thus the entire system. A number of siphon tubes 28 are provided for this purpose. While two tubes 28 are shown, more or less may be used depending on the flow required. According to a well-known siphon principle, if the exit to the siphon 30 is below the entrance to the siphon 28, water exiting the siphon will draw additional water into the siphon causing a continuous flow of water from the trough into the reservoir. As with the up pipes 18, it may be necessary to fill the siphon tubes 28 prior to starting the system to ensure that a flow will occur in the siphon tubes 28 at start up. A brace 41 may be provided to locate and support the tubes 28 in a proper position above the trough and out of contact with the rotating up pipes 18 and the reservoir 10.

A housing 48 surrounds the entire device to reduce extraneous forces and disturbances upon the water lift system. The housing also helps reduce evaporation or other losses to the system and provides a basis for supporting the various rotating and fixed bodies of the system.

A number of bearings 8 may be provided between rotational parts and stationary parts or between counter rotating parts to reduce friction. By way of example, a bearing 8 may be provided between the rotating shaft 6 and the stationary housing 48. A bearing 8 may also be provided at the bottom of the housing 48 and the bottom of the shaft 6. The bearing may be of such shape and configuration as to support loads on the bearing, whether the loading is rotational, weight, thrust, etc. Additionally a bearing (not shown) may be provided between the shaft 6 of the central reservoir and the counter rotating basin 14. A seal (not shown) may also be provided between the shaft, the bearing and the basin to prevent fluid from leaking between the counter-rotating parts. One skilled in the art would recognize that additional supports, seals and bearing may be provided throughout the device without departing from the scope of the invention.

Located above the top bearing may be provided a generator 45. The central reservoir is affixed to the central shaft 6, and thus rotation of the reservoir causes rotation of the shaft 6. The rotation of the shaft will drive the generator 45, which converts the rotational motion into electricity.

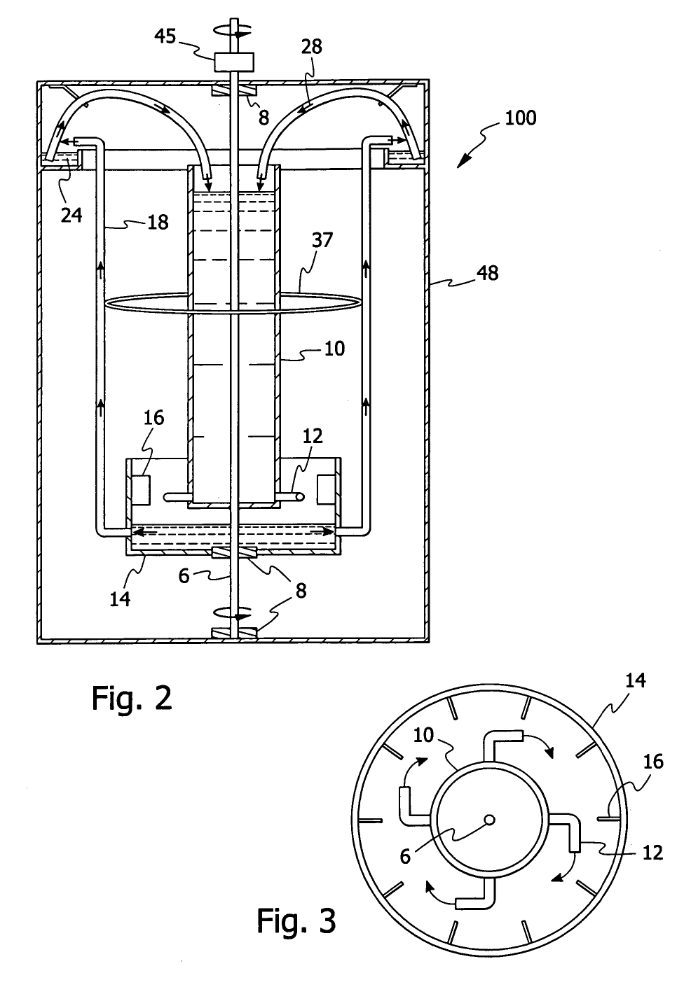

With referral to FIGS. 2 & 3, a diagrammatic operation of a simplified system 100 is shown to illustrate water flow through In operation, the central reservoir 10 is filled with a predetermined amount of water. The up pipes 18 and the siphons 28 are also filled with water in preparation of the water lift being operated. A certain amount of water can also be introduced to basin 14 and trough 24 so that water can flow continuously throughout the system without running “dry” in any section while water begins to flow from the central reservoir. Additionally, a replenishing supply (not shown) of water or other fluid can be provided to the central reservoir to maintain or add to the rotational velocity of the reservoir 10, to replace evaporating fluids or to otherwise regulate the output of the water lift system.

After the system has been appropriately filled with the motive fluids, the system is allowed to rotate under the power of the fluid. If necessary, initial velocity may be provided to the various parts to overcome inertia, to facilitate initial flows or to set the desired rotational velocity of the system. Pre-rotation may also be necessary to ensure that the centrifugal force always exceeds the natural gravitational pull of the water to prevent for example, a reverse flow in the up pipes 18 as the water would fall under the action of gravity without sufficient rotational velocity of the up pipes.

After an initial period, the water lift system will be self-driving. Water exiting the jets 12 at the bottom of the reservoir will cause the reservoir to continue rotating in the counterclockwise direction by converting the potential energy of the water reservoir into kinetic energy. The rotation of the reservoir and the shaft 6 will drive the generator (see FIG. 1, #45) to extract electrical energy from the rotational velocity of the reservoir.

A portion of the kinetic energy of the water in the jets 12 will be used to drive the fins 16 of the basin causing the basin 14 to rotate counter to the reservoir. This rotation will influence water in the basin and up pipes 18 by creating a centrifugal force on the water driving the water into the up pipes. The siphon action of water exiting the up pipes into the trough 24 combined with the centrifugal force will allow the water in the up pipes to be lifted a distance from the basin to the trough, thus converting some of the kinetic energy back to potential energy. The water in the trough 24 is then siphoned from the trough through the siphons 28 into the central reservoir where it can again be converted into kinetic energy to rotate the central reservoir and the basin in opposing directions. In this way, the rotation of the system can continue for extended periods of time, while creating energy through the electrical generator. Additional water, and thus additional potential energy, can be added to the system periodically to help perpetuate the rotation of the system.

It is to be understood that the present invention is not limited to the sole embodiment described above, but encompasses any and all embodiments within the scope of the following claims.

I claim:

1. A water circulation system comprising:
a) a central reservoir for holding water rotatably mounted above a catch basin;
b) said reservoir having a plurality of outlet jets mounted in communication with said reservoir for expelling water from said reservoir and for providing rotational velocity to said reservoir;
c) said catch basin rotatably mounted independent from said central reservoir and having a number of fins arranged to receive water from said outlet jets for providing a counter rotational velocity to said basin;
d) a plurality of up pipes in fluid communication with said catch basin for lifting water from said catch basin to at least one trough;
e) at least one siphon tube in fluid communication with said at least one trough for carrying water from said trough to said central reservoir.

2. The water circulation system of claim 1, wherein at least a portion of said water in said reservoir flows from said reservoir through said catch basin through said up pipes through said trough and back to said reservoir.

3. The water circulation system of claim 2, wherein said water circulation system comprises at least two up pipes.

4. The water circulation system of claim 1, wherein said water circulation system comprises at least four up pipes.

5. The water circulation system of claim 1, wherein said water circulation system comprises at least two siphon tubes.

6. The water circulation system of claim 1, further comprising an electric generator connected to said housing for converting the rotational velocity of said reservoir into electrical energy.

7. The water circulation system of claim 1, further comprising an electric generator connected to a shaft connected to said housing for converting the rotational velocity of said reservoir into electrical energy.

8. The water circulation system of claim 1, further comprising a housing surrounding said water circulation system.

9. The water circulation system of claim 1, further comprising a brace connecting said plurality of up pipes.

10. The water circulation system of claim 1, further comprising a brace connecting said plurality of up pipes.

11. The water circulation system of claim 10, wherein said brace is ring shaped.
